(19) United States
(12) Patent Application Publication
(10) Pub. No.: US 2009/0095855 A1
(43) Pub. Date: Apr. 16, 2009

(54) TRIPOD FOR ELECTRONIC DEVICE

(75) Inventor: CHIH-CHUNG SU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/051,690

(22) Filed: Mar. 19, 2008

(30) Foreign Application Priority Data
Oct. 16, 2007 (CN) 200710202070.5

(51) Int. Cl. F16M 11/04

(52) U.S. Cl. 248/177.1

(57) ABSTRACT

A tripod for an electronic device includes a head, a connecting portion, a battery, and a support portion. The head is configured for mounting the electronic device thereon. The connecting portion is connected to the head. The battery is electronically connectable to the electronic device and configured for providing power to the electronic device when connected. The support portion is connected to the connecting portion and includes a hollow container configured for receiving the battery. The tripod can provide at least one reserve battery in the hollow container of the support portion. Therefore, the working time of the electronic device may be extended.

### RELATED FILED

The present invention relates to a tripod, and more particularly, to a tripod having a hollow container for receiving a battery.

### BACKGROUND

As is well known, tripods are used for a variety of purposes. For example, tripods are used to support cameras (both still and motion), telescopes, surveying apparatus, binoculars, transits, and all manner of equipment. When people work in the field utilizing these electronic devices, such as taking pictures with a camera, battery life becomes an important issue. Until now, the conventional tripods are no help with this issue as they only function to support the electronic device.

It is desired to provide a tripod for an electronic device which can overcome the above-described deficiency.

### SUMMARY

According to the present invention, a tripod for an electronic device includes a head, a connecting portion, a battery, and a support portion. The head is configured for mounting the electronic device thereon. The connecting portion is connected to the head. The battery is electronically connectable to the electronic device and configured for providing power to the electronic device when connected. The support portion is connected to the connecting portion and includes a hollow container configured for receiving the battery.

Other novel features and advantages will become more apparent from the following detailed description when taken in conjunction with the accompanying drawings.

### BRIEF DESCRIPTION OF THE DRAWINGS

The present invention is described in detail hereinafter, by way of example and description of preferred and exemplary embodiments thereof and with reference to the accompanying drawings, in which:

FIG. 1 is an isometric view of a tripod for an electronic device in accordance with the present invention;

FIG. 2 is similar to FIG. 1, but further includes a camera mounted on a head of the tripod; and

FIG. 3 is similar to FIG. 1, but further includes a charger.

### DETAILED DESCRIPTION OF THE PREFERRED EMBODIMENTS

A detailed explanation of a tripod for an electronic device according to an embodiment of the present invention will now be made with reference to the drawings attached hereto.

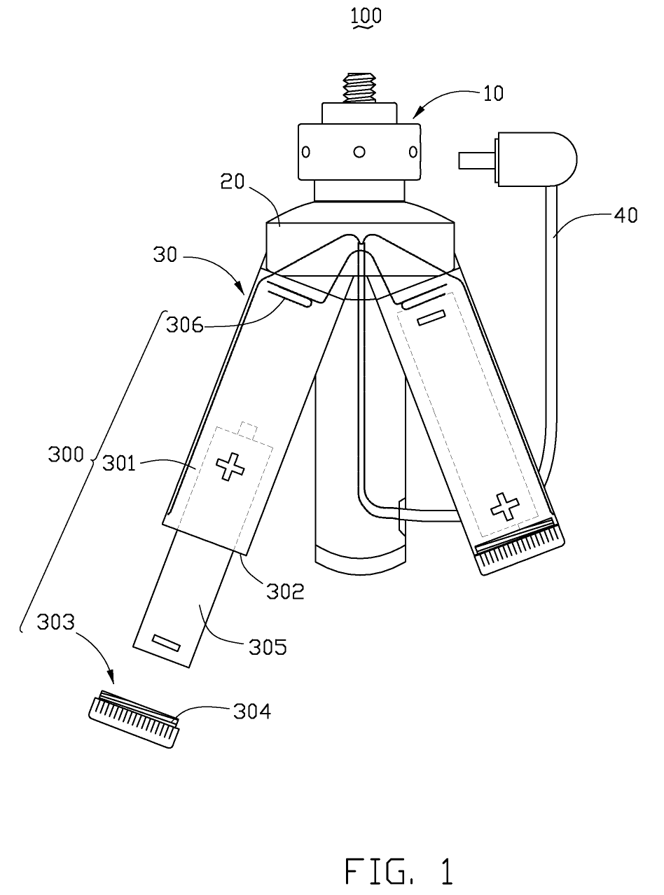

Referring to FIGS. 1-3, a tripod 100 for an electronic device according to the present embodiment is shown. The tripod 100 includes a head 10, a connecting portion 20 connected to the head 10, and a support portion 30 connected to the connecting portion 20.

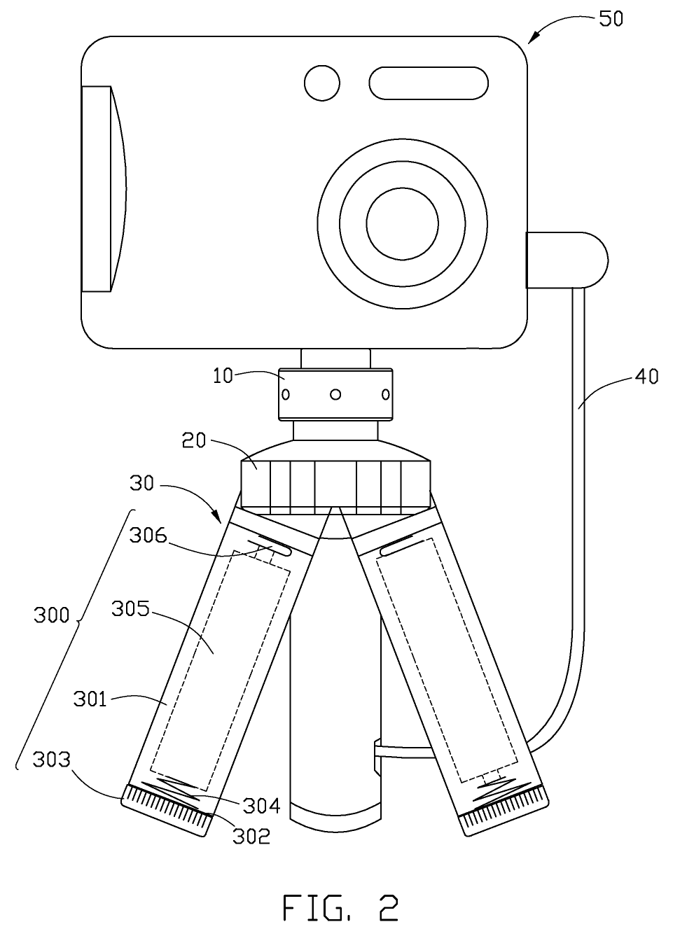

The electronic device can be a camera, a telescope, a surveying apparatus, and so on. In the present embodiment, as shown in FIG. 2, the electronic device is a camera 50. The camera 50 is presented only as an example to explain working principles of the tripod 100.

The head 10 is configured for mounting the camera 50 thereon and is rotatably attached to the connecting portion 20.

The connecting portion 20 is configured for positioning the head 10 and receiving a top end of the support portion 30.

The support portion 30 includes three legs 300 (only a leg is labeled) are shown in this embodiment, and each leg 300 can radially and downwardly extend from the connecting portion 20. Configurations and working principles of the three legs 300 are same relative to each other. Therefore, one of the legs 300 is presented as an example to explain configurations and working principles of the three legs 300. The leg 300 includes a hollow container 301 defined therein. The hollow container 301 can be a cylinder and configured for receiving a battery 305 therein as well as acting as a leg to support the connection portion 20 and the head 10. The hollow container 301 has an opening 302 configured for inserting the battery 305 into the hollow container 301 therethrough. The leg 300 further includes a cover 303 threadedly engaged with the opening 302 of the hollow container 301. The cover 303 is configured for sealing the opening 302 to hold the battery 305 in the hollow container 301. It can be appreciated that the cover 303 includes a metal spring 304 formed at an inner side thereof for electrically contacting with the cathode of the battery 305 and the hollow container 301 includes a metal leaf 306 disposed in an inner top side thereof for electrically contacting with anode of the battery 305 when the battery 305 is inserted into the hollow container 301. The battery 305 is firmly retained in the hollow container 301 after the cover 303 is manually threaded into the hollow container 301.

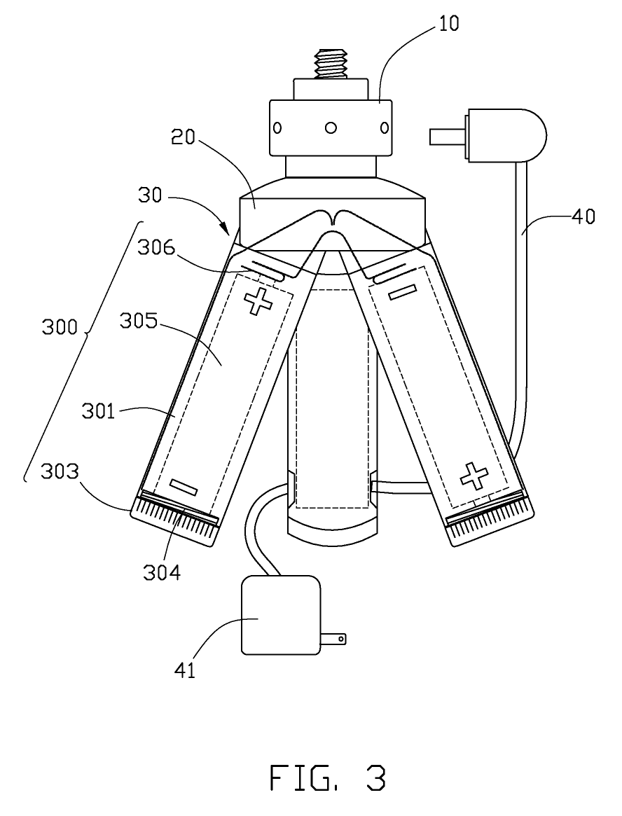

Understandably, the tripod 100 further includes a wire 40 electrically connected to the battery 305 and connectable to the camera 50 so that the battery 305 can supply power to the camera 50. It can be appreciated that the tripod 100 may further include a charger 41, as shown in FIG. 3, electrically connected to the battery 305 and configured for charging the battery 305.

In use, as shown in FIG. 2, the three legs 300 of the support portion 30 are opened out and fully extended and the camera 50 is mounted on the head 10 of the tripod 100. The battery 305 received in the hollow container 301 can provide power to the camera 50 when the camera's own battery has run out of power.

As described above, the tripod 100 can provide at least one reserve battery in the hollow container 301 of the support portion 30. Therefore, the working time of the electronic device may be extended.

It should be understood that the above-described embodiment are intended to illustrate rather than limit the invention. Variations may be made to the embodiments without departing from the spirit of the invention. Accordingly, it is appropriate that the appended claims be construed broadly and in a manner consistent with the scope of the invention.

What is claimed is:

1. A tripod for an electronic device, comprising:
a head configured for mounting the electronic device thereon;
a connecting portion connected to the head;
a battery being electronically connectable to the electronic device and configured for providing power to the electronic device when connected; and
a support portion connected to the connecting portion and comprising a hollow container defined therein and configured for receiving the battery.

2. The tripod as claimed in claim 1, wherein the hollow container is a cylinder.

3. The tripod as claimed in claim 1, wherein the support portion comprises three legs, each of the legs comprises a hollow container defined therein, and each of the hollow containers has an opening.

4. The tripod as claimed in claim 3, wherein each of the legs further comprise a cover configured for sealing the opening of the hollow container.

5. The tripod as claimed in claim 3, wherein an inner side of the cover comprises a metal spring configured for tightly connected to cathode of the battery.

6. The tripod as claimed in claim 1, wherein the hollow container includes a metal leaf disposed in an inner top side thereof for electrically contacting with anode of the battery.

7. The tripod as claimed in claim 1, further comprising a charger electrically connected to the battery and configured for charging the battery.
